(19) United States
(12) Patent Application Publication
(10) Pub. No.: US 2010/0307112 A1
(43) Pub. Date: Dec. 9, 2010

(54) FOUR-PIECE SPOUT ASSEMBLY

(75) Inventor: Anders Andersen, Esbjerg (DK)

Correspondence Address: FISH & RICHARDSON P.C. (NY), P.O. BOX 1022, MINNEAPOLIS, MN, 55440-1022, US

(73) Assignee: SEELEN A/S, Esbjerg (DK)

(21) Appl. No.: 12/780,771

(22) Filed: May 14, 2010

(30) Foreign Application Priority Data
May 28, 2009 (EP) 09007141.6

(51) Int. Cl. B65B 11/02; B65G 11/00

(52) U.S. Cl. 53/397; 193/2 R

(57) ABSTRACT

The invention relates to a four-piece spout assembly used in a packaging machine for packaging compressible objects. The four-piece spout assembly comprises four L-shaped profiles which can be unidirectional or bidirectional adjusted so as to accommodate different sizes of one or multiple compressible objects. The invention further relates to an adjustable pusher for directing the compressible object through the opening of four-piece spout assembly.

The invention relates to a four-piece spout assembly used in a packaging machine for packaging compressible objects. The invention further relates to a method for packaging at least one compressible object in a foil using a four-piece spout assembly.

### BACKGROUND

During the wrapping of one or more compressible objects it is common to use a spout. The compressible object(s) are pushed into and through a spout with the use of a pusher. Wrapping foil is fitted tightly around the outside of the spout and as the compressible object(s) are pushed through the spout, the wrapping foil is wrapped around the compressible object(s), thereby covering the four or five sides of a larger packet of compressible object(s) with foil.

The dimensions of the wrapped packet of compressible object(s) will be of a specific size depending on the compressibility of the object(s) and the size requirements defined by the later transportation. Hence, several different sizes of spouts and wrapping foil are needed to wrap different types of compressible object(s) and one needs to change between them accordingly. This increases the down time of e.g. a production line, and makes the packaging of compressible objects inflexible.

Previously, in order to avoid having to change between different spouts, a two-piece spout with U-shaped profiles has been applied. The distance between these two U-shaped profiles can be unidirectional adjusted, either horizontally or vertically. The problem with this adjustability is its unidirectional limitation. This e.g. means that depending on the orientation of the U-shaped profiles, these have to be changed when the width or height of the compressible objects to be packed changes. Hence, the down time and inflexibility is not reduced sufficiently with this two-piece spout.

### DESCRIPTION OF THE INVENTION

The present invention relates to a four-piece spout assembly to be used when packaging compressible objects, said assembly comprising four profiles, where said profiles together form the opening of said spout and where the position of said profiles can be adjusted towards or away from each other, whereby the size of said opening can be adjusted.

The four pieces of the spout are constructed as “bended” L's. Instead of having a 90 degree angle corner between the two sides, the corner is “bended” making it an L with three sides. This strengthens the corners significantly insuring that the spout can withhold a high pressure from the compressed material without the sides starting to bend as observed with conventional L-shaped sides.

The four pieces in the four-piece spout are fitted together such that one side of the piece lies on top of the next piece, whereas the other side lies below the previous piece. Apart from forming a substantial uniform inner circumference, this embodiment of the pieces also serves to strengthen the bending properties of the oblong sides of the piece.

The two main sides of the bended L's can have the same length or one can be longer than the other.

The four bended L's can all have the same size. Alternatively, they are similar in size two and two.

The dimension of the spout is such that one side is longer than the longest side of the bended L's and shorter than two times the longest side of the bended L's. The other side of the spout is longer than the shortest side of the bended L's and shorter than two times the shortest side of the bended L's.

In one embodiment of the invention, one of the bended L's is fixed in position and the other three are moved to create different spout dimensions. Moving the pieces is computer controlled.

In another embodiment of the invention, all four pieces can be moved individually.

In one embodiment of the invention the size of the spout ranges from 210 cm to 340 cm vertically and from 410 cm to 600 cm horizontally.

The wrapping foil employed to wrap the compressed object(s) can have the shape of a bag open in both ends. One advantage with the four-piece, is the easiness with which these wrapping bags can be put in place. By adjusting the spout to a smaller dimension than the wrapping bag, the wrapping bag can be pulled over the spout and into place with no difficulty. The spout is afterwards adjusted to the correct dimension thereby placing the foil tightly around the spout as desired.

One advantage with using the bended L's in the four-piece spout is that the wrapping bag will not break at the corners of the spout, since the stress on the wrapping bag at that position is much reduced compared to a sharp cornered L-profile.

Another advantage of the bended corners, is that less foil is used when wrapping the compressed object(s).

Different compressible object(s) often require spouts with different dimensions (length and height). However, the circumference of the wrapped packed might still be the same. As a consequence, the same wrapping bag/foil can be used to wrap object(s) of different length and height as long as the circumference is the same. This has two advantages: 1) it saves time, since the wrapping bag does not need to be changed, and 2) it saves money, since a lower number of different wrapping bags are needed.

In one embodiment of the invention, the inside of the spout is air-lubricated. This insures minimum friction between the compressible object(s) and the spout.

When pushing compressible object(s) through a spout, it is essential that the object(s) are pushed with an even force over the whole area. Otherwise the object(s) can be damaged. The pushing-arm comprised in this invention ensures that an even force is applied over the entire area of the compressed object(s) by being adjustable in size to match the dimensions of the spout.

In an embodiment the assembly further comprises an adjustable pusher for directing said at least one compressible object through the opening of said four profiles. Thereby the surface of the pusher being in contact with the compressible object to be pushed can be adjusted so that the size corresponds with the pushing surface of the objects, and the risk of damaging the compressible object is reduced.

The adjustable pusher comprises a pusher mounted to a primary plate, comprising a primary plate and a side plate hingedly mounted to said primary plate and in an embodiment also a top plate hingedly mounted to said primary plate. Thereby making it possible to adjust the size of the pusher both in height and in width.

In a specific embodiment the adjustable pusher further comprises at least one stop/lock plate used to stop or lock the position of said side plate and/or at least one stop/lock plate used to stop or lock the position of said top plate.

The invention further relates to a method for packaging at least one compressible object in a foil using a four-piece spout assembly, comprising the steps of:
placing said foil on the outer side of said four-piece spout assembly,
stretch said foil by adjusting the four-piece spout assembly, so that the opening of said four-piece spout assembly can accommodate the size of said at least one compressible object
directing said at least one compressible object through the opening of said four-piece spout assembly, whereby said at least one compressible object is gradually covered in said foil on the outer side of said four-piece spout assembly.

In an embodiment the method further comprising the step of:
directing said at least one compressible object through the opening of said four-piece spout assembly by using an adjustable pusher.

### BRIEF DESCRIPTION OF THE DRAWINGS

FIG. 1 illustrates a four-piece spout assembly 100 for use in a packing machine.

FIG. 2 illustrates a perspective of the four L-shaped profiles of the four-piece spout assembly on FIG. 1

FIG. 3a-d illustrate an end view of the four L-shaped profiles of the four-piece spout assembly in four different positions.

FIG. 4 illustrates an embodiment of the L-shaped profiles of the four-piece spout assembly.

FIG. 5 illustrates an embodiment of the L-shaped profiles of the four-piece spout assembly.

FIGS. 6a and 6b illustrate a perspective of one embodiment of the adjustable pusher.

FIGS. 7a and 7b illustrate a perspective of the adjustable pusher set in another position.

### DESCRIPTION OF EMBODIMENTS

FIG. 1 illustrates a four-piece spout assembly 100 for use in a packing machine. The spout assembly 100 comprises four L-shaped profiles 120, 122, 124, 126, which can be adjusted to accommodate different sizes of compressible objects (not shown in the figure). In this embodiment, the L-shaped profile 122 is in a fixed position. The L-shaped profile 124 and 120 can be moved unidirectionally along a horizontally oriented and vertically oriented axis, respectively. The L-shaped profile 126 can be moved bi-directionally along horizontally oriented and vertically oriented axes. The movement of the L-shaped profiles 120, 124, 126 is enabled by means (not indicated) of e.g. tracks and/or pneumatic cylinders (not indicated). These means are fastened to a frame 130 which defines the extent, to which the L-shaped profiles 120, 124, 126 can be moved. In this embodiment the four L-shaped profiles 120, 122, 124, 126 extend through and on both sides of the frame 130. The open end space defined by the four L-shaped profiles 120, 122, 124, 126 on FIG. 1 is the exiting end 132. The packaging machine incorporating the four-piece assembly 100 of the present invention can be included in a larger production line, where e.g. the compressible objects are both produced and following packed. By having the L-shaped profile 122 in a fixed position, it is easier to position the belt (not shown) conveying the compressible objects. Hence, the L-shaped profile 122 could advantageously be placed so that the inside of the corner substantially levels with one of the edges of one of the conveyor belts (not shown). In another embodiment one of the other L-shaped profiles 120, 124, 126 can be placed in a fixed position. In an alternative embodiment the L-shaped profiles 120, 122, 124, 126 can all be moved bi-directionally along e.g. both horizontally oriented and vertically oriented axes.

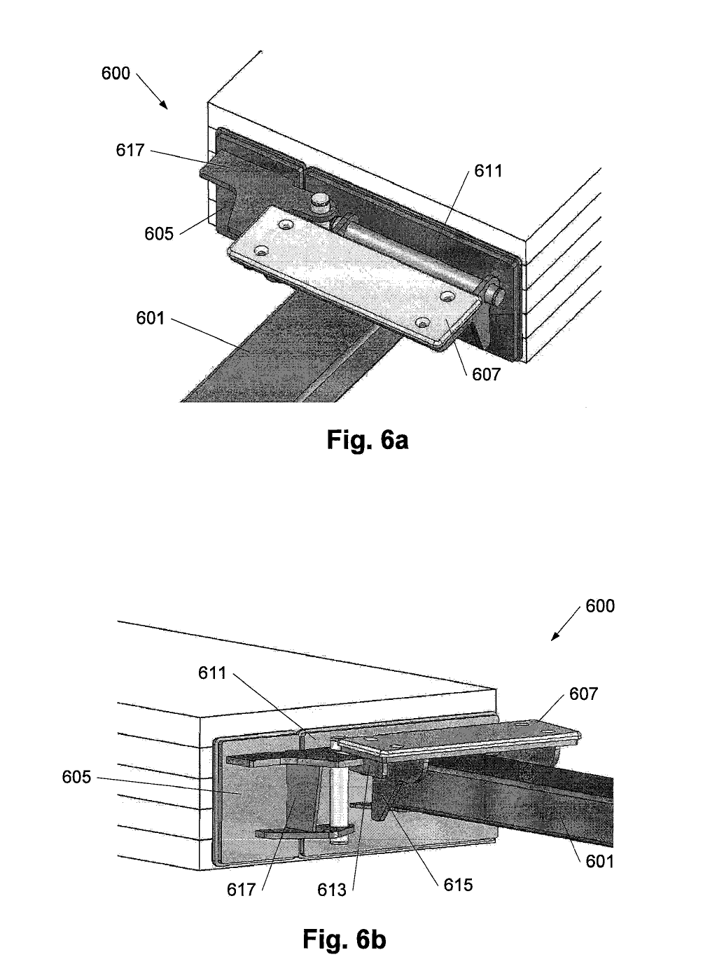

The packaging procedure using the four-piece spout assembly 100 (FIG. 1) proceeds as follows. In the present example a stack of compressible objects are conveyed towards the packaging machine comprising the four-piece spout assembly 100. Before the compressible objects reach the four-piece spout assembly, the four L-shaped profiles 120, 122, 124, 126 are moved to a position where a foil bag or a ring of foil can be fitted around the exiting end 132 (or outlet) of the L-shaped profiles 120, 122, 124, 126. The L-shaped profiles 120, 124, 126 are hereafter moved to other positions, so that they form a space where through the compressible objects can pass. By moving the L-shaped profiles 120, 124, 126 to other positions the foil bag or ring of foil is stretched. When the compressible objects have been conveyed to a position in front of the entering end of the L-shaped profiles 120, 122, 124, 126 an adjustable pusher 600 (see description in FIG. 6a-b and 7a-b) pushes the compressible objects through the space formed by the four L-shaped profiles 120, 122, 124, 126. As the compressible objects exit the four-piece spout assembly 100, they will gradually be covered in the foil bag or ring of foil. When the compressible objects exit the space formed by the four L-shaped profiles 120, 122, 124, 126 at least the sides of the compressible objects facing the inside of the four L-shaped profiles 120, 122, 124, 126 will be covered in foil. The compressible objects can be pushed through the four-piece spout assembly in both an uncompressed and compressed state.

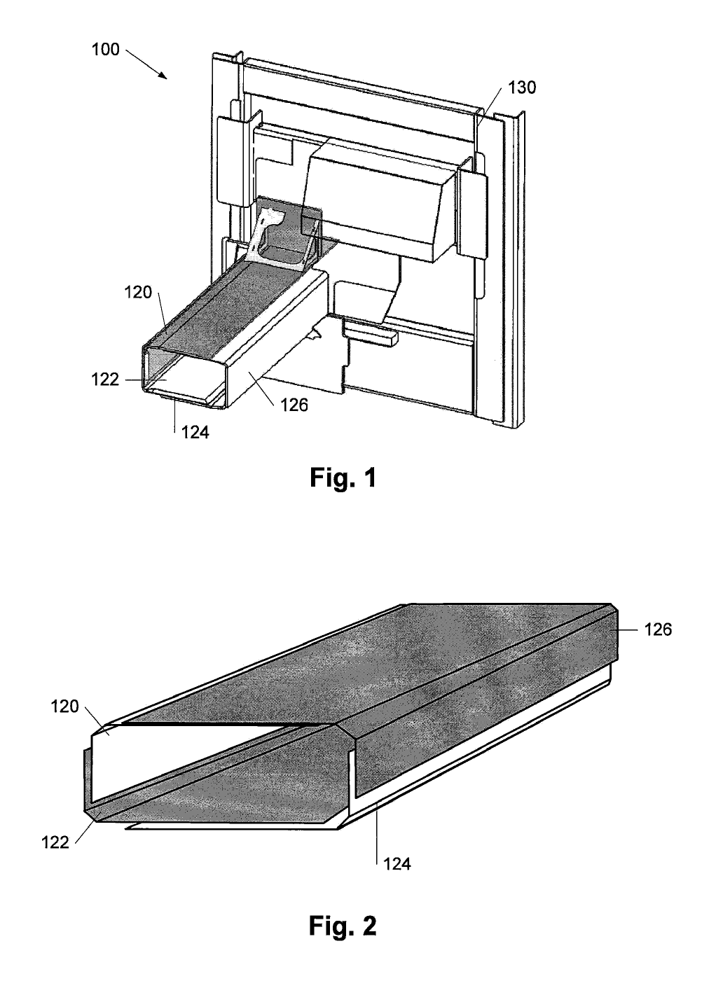

FIG. 2 illustrates a perspective of the four L-shaped profiles 120, 122, 124, 126 of the four-piece spout assembly 100 (FIG. 1) seen from the exiting end 132. The L-shaped profiles 120, 122, 124, 126 are depicted in a position, where the space defined by the profiles is minimum. That is, the profiles 120, 122, 124, 126 cannot be moved or positioned closer to each other.

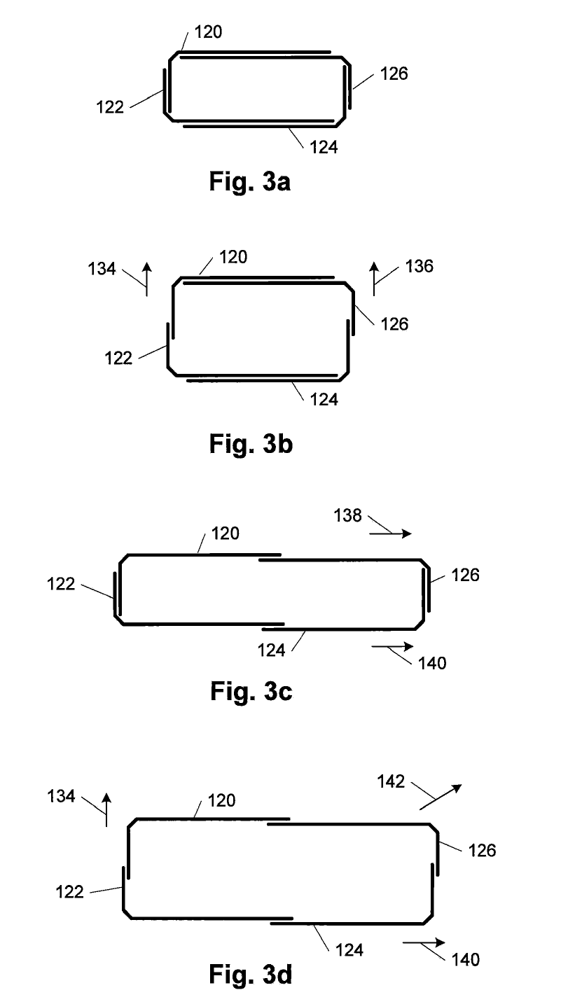

FIG. 3a-d illustrate an end view of the four L-shaped profiles 120, 122, 124, 126 in four different positions. The profiles are in these figures arranged analoguely to the embodiment described in FIG. 1; meaning that the L-shaped profile 122 is in a locked position. The position of the L-shaped profiles 120, 122, 124, 126 in FIG. 3a is similar to the position depicted in FIG. 2. In FIG. 3b, the L-shaped profiles 120, 126 have been moved upwards along a vertically oriented axis indicated by arrows 134, 136. In FIG. 3c, the L-shaped profiles 124, 126 have been moved to the right along a horizontally oriented axis indicated by arrows 138,140. Finally, in FIG. 3d, the L-shaped profile 120 has been moved upwards along a vertically oriented axis indicated by arrow 134. The L-shaped profile 124 has been moved to the right along a horizontally oriented axis as indicated by arrow 140. Finally, the L-shaped profile 126 has been moved both upwards and to the right, resulting in a direction as indicated by arrow 142. The compressible objects (not shown) are preferably directed into the spout when the L-shaped profiles 120, 122, 124, 126 overlap, to e.g. avoid that the compressible objects are torn. However, there can be situations where such a limitation in the relative position of the L-shaped profiles 120, 122, 124, 126 is not necessary. Hence, in such situations an overlap is not necessary.

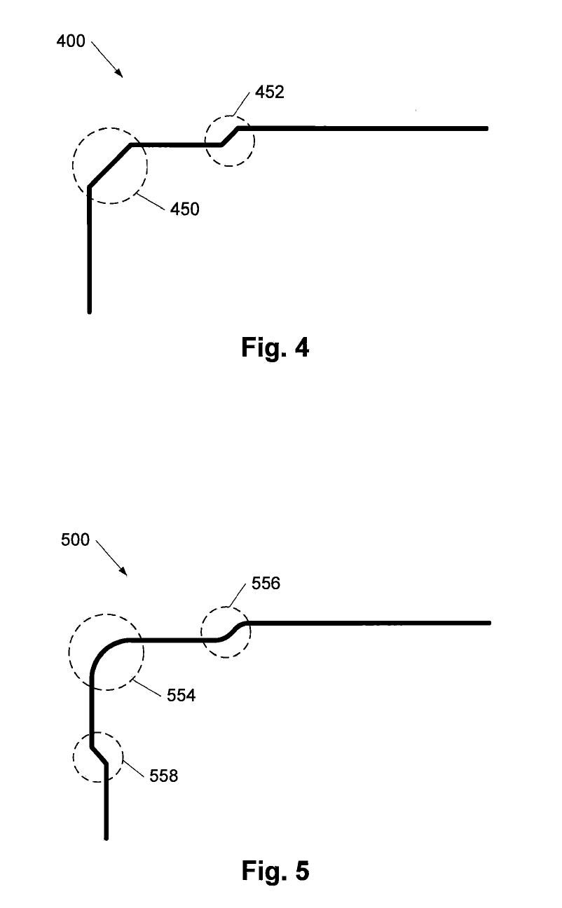

FIGS. 4 and 5 illustrate different embodiments of the L-profiles of the four-piece spout assembly 100. For the sake of simplicity, only one L-shaped profile 400, 500 is illustrated on FIGS. 4 and 5, respectively. The L-shaped profiles 400, 500 comprise a number of bends or folds 450, 452, 554, 556 and 558. Although the surface areas of the two sides of the L-shaped profiles are perpendicularly oriented relative to each other, the approximately 90 degrees between the two sides can be a curved bend 554 or be comprised by a number of bends 450. The two sides further comprise bends 452, 556, 558. The L-shaped profiles 400, 500 are embodied in this way in order to enhance the stiffness of the profiles and thereby their resistance to e.g. a bending moment. This is needed as the L-shaped profiles 400, 500 are influenced by different forces and bending moments during the packaging process. These forces and bending moments can be caused by the foil when, after it has been placed on the L-shaped profiles, it is stretched so that the space formed by the L-shaped profiles can accommodate width and height of the compressible object(s) to be pushed through that space. A greater force and bending moment can also be caused by the expansion forces (the potential energy) of the compressible objects when they are pushed through the space formed by the L-shaped profiles in a compressed state. To better accommodate these forces and bending moments, the thickness of the L-shaped profiles 400, 500 could be increased. However, in order to avoid plastic deformation, tearing or breaking the foil when it is stretched, the material thickness of the L-shaped profiles must be as small as possible. The bendings of the L-shaped profiles are also used to make a substantially uniform surface from one L-shaped profile to the other. The bends or folds 450, 452, 554, 556, and 558 along the sides of the L-shaped profiles 400, 500 also serve to make better overlaps between the L-shaped profiles of the four-piece spout assembly.

FIGS. 6a and 6b illustrate a perspective of one embodiment of an adjustable pusher 600 employed to push object(s) through the four-piece spout assembly (not shown, see FIG. 1). The adjustable pusher 600 can be adjusted to specific dimensions, e.g. of 210 cm vertically and 600 cm horizontally, so as to fit the opening of the four-piece spout assembly. The pusher 600 comprises a pusher 601, a primary plate 611, a side plate 605 and a top plate 607. Both the side plate 605 and the top plate 607 are hingedly connected to the primary plate 611 and can be pivoted so that they serve as an extension of the surface area of the primary plate 611. The side plate 605 and the top plate 607 can also be pivoted to a position behind the primary plate 611, such that the surface of the side plate 605 and the top plate 607 is perpendicular to the surface of the primary plate 611. The movement of the side plate 605 and the top plate 607 is enabled by means of the adjustment device (not shown). In FIGS. 6a and 6b the adjustable pusher 600 is adjusted so that the side plate 605 is directed to a position so that it increases the width of the primary plate 611. Thus, the surface of the side plate 605 serves as an extension piece to the surface of parallel to the primary plate 611. The top plate 607 is pivoted backwards, such that its surface is perpendicular to the surface of the primary plate 611. The adjustable pusher 600 is normally adjusted such that either the side plate 605 or the top plate 607 is pivoted to extend the surface area of the primary plate 611.

The side plate 605 further comprises a stop/lock profile 617, and the top plate 607 comprises a stop profile 613 and a lock profile 615. These profiles are used to reduce the force exerted on the adjustment device (not shown) when the pusher is in operation; that is when it pushes the compressible objects through the opening of the four-piece spout assembly (not shown). This means that during operation of the adjustable pusher 600 as set in FIGS. 6a and 6b, the compressible object(s) will exert a force on both the primary plate 611 and the side plate 605. The force exerted on the side plate 605 is transferred both through the adjustment device (not shown) and also through the stop/lock profile 617 to the stop profile 613 of the top plate 607.

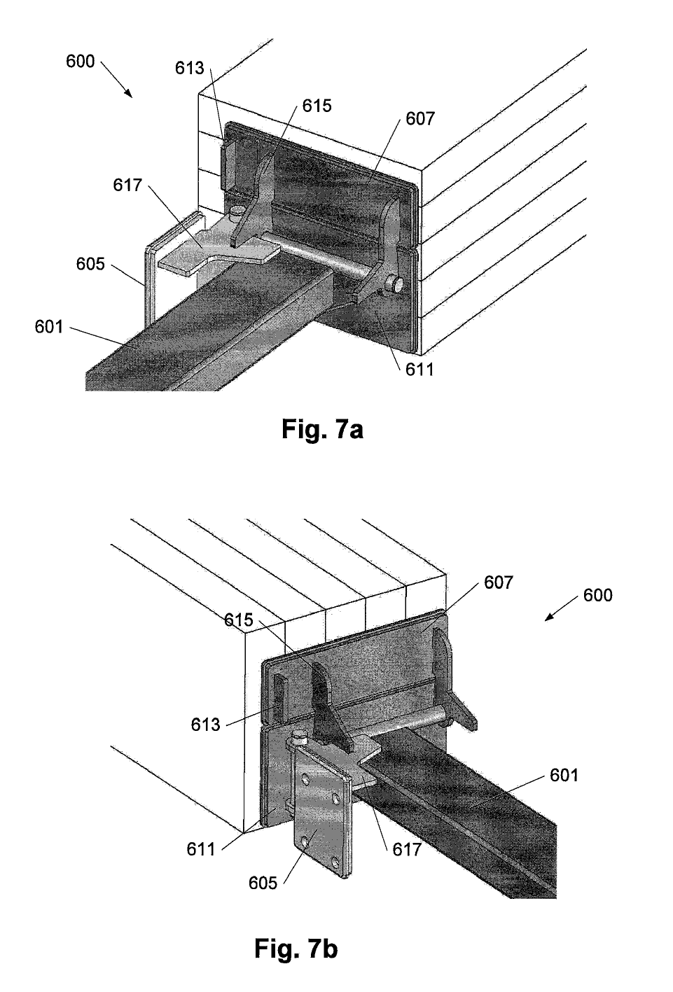

FIGS. 7a and 7b illustrate a perspective of another setting of the adjustable pusher 600. Here the top plate 607 is pivoted out so that it extends the surface area of the primary plate 611, e.g. to the dimensions of 340 cm vertically and 410 cm horizontally. The side plate 605 is pivoted backwards so that its surface area is perpendicular to the surface area of the primary plate 611. The lock profile 615 of the top plate 607 rests on the stop/lock profile 617 of the side plate 605. Hereby force exerted on the top plate 607 during operation is transferred via the lock profile 615 to the stop/lock profile 617. This means that the force exerted on the adjustment device (not shown) is reduced. Hereby the adjustment device (not shown) can be designed with smaller dimensions.

### REFERENCES

100 four-piece spout assembly
120 L-shaped profile
122 L-shaped profile
124 L-shaped profile
126 L-shaped profile
130 frame
134 arrow, indicating a direction of movement
136 arrow, indicating a direction of movement
138 arrow, indicating a direction of movement
140 arrow, indicating a direction of movement
142 arrow, indicating a direction of movement
400 L-shaped profile
500 L-shaped profile
600 adjustable pusher
601 pusher
605 side plate
607 top plate
611 primary plate
613 stop profile
615 lock profile
617 stop/lock profile

1. A four-piece spout assembly to be used when packaging compressible objects, said assembly (100) comprising four profiles (120, 122, 124, 126), where said profiles (120, 122, 124, 126) together form the opening of said spout, and where the position of said profiles (120, 122, 124, 126) can be adjusted towards or away from each other, whereby the size of said opening can be adjusted.

2. A four-piece spout assembly (100) according to claim 1, where the position of at least one of said four profiles (120, 122, 124, 126) is fixed.

3. A four-piece spout assembly (100) according to claims 1-2, where said four profiles (120, 122, 124, 126) have an L-shape.

4. A four-piece spout assembly (100) according to claims 1-3, where said four profiles comprise at least one bend or fold (450, 452, 554, 556, 558).

5. A four-piece spout assembly (100) according to claims 1-4, further comprising an adjustable pusher (600) for directing said at least one compressible object through the opening of said four profiles (120, 122, 124, 126).

6. A four-piece spout assembly (100) according to claim 5, where said adjustable pusher (100) comprises a pusher (601) mounted to a primary plate (611).

7. A four-piece spout assembly (100) according to claims 5-6, where said adjustable pusher (600) further comprises a side plate (605) hingedly mounted to said primary plate (611).

8. A four-piece spout assembly (100) according to claims 5-7, where said adjustable pusher (600) further comprises a top plate (607) hingedly mounted to said primary plate (611).

9. A four-piece spout assembly (100) according to claims 5-8, where said adjustable pusher (600) further comprises at least one stop/lock plate (617) used to stop or lock the position of said side plate (605).

10. A four-piece spout assembly according to claims 5-9, where said adjustable pusher (600) further comprises at least one stop/lock plate (613, 615) used to stop or lock the position of said top plate (607).

11. A method for packaging at least one compressible object in a foil using a four-piece spout assembly (100), comprising the steps of:
placing said foil on the outer side of said four-piece spout assembly (100)
stretching said foil by adjusting (134, 136, 138, 140, 142) the four-piece spout assembly (100), so that the opening of said four-piece spout assembly can accommodate the size of said at least one compressible object
directing said at least one compressible object through the opening of said four-piece spout assembly (100), whereby said at least one compressible object is gradually covered in said foil on the outer side of said four-piece spout assembly.

12. A method according to claim 11, further comprising the step of:
directing said at least one compressible object through the opening of said four-piece spout assembly by using an adjustable pusher.
